(19) United States
(12) Patent Application Publication
(10) Pub. No.: US 2008/0124948 A1
(43) Pub. Date: May 29, 2008

(54) Connector Structure for a Vehicular Light

(76) Inventor: Yu-Chu Lin, Tainan Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/563,206

(22) Filed: Nov. 26, 2006

(51) Int. Cl. H01R 33/00

(52) U.S. Cl. 439/36

(57) ABSTRACT

A connector structure for a vehicular light includes a connecting base. The connecting base has a compartment at one end and an insertion section at the opposite end thereof. The insertion section is disposed with holes interconnecting with the compartment. The compartment is provided with electric wires which extend through the holes and connect with electric contact points. The insertion section of the connecting base is inserted into a light base of a vehicular light for lighting up lighting elements.

### BACKGROUND OF THE INVENTION

1. Field of the Invention

The present invention relates to a connector structure for a vehicular light, in particular to a connecting base formed with an insertion section for a modified illumination device to be connected with a slot already built-in a vehicular light.

2. Description of the Prior Art

Vehicle lights are most important for a driver to avoid an accident. The traditional design is to insert an insertion end (A1) of a bulb (A) into a slot (B2) of a socket (B1) of a light base (B) that provides electric power to lighten the bulb (A), as shown in FIG. 4. This design is simple in structure with the single bulb (A) in relation to the single slot (B2). If multiple bulbs (A) are desired, it is required to add the number of the slots (B2). If the user wants to change a different type of bulb (A), it is required to replace another slot (B2) in order to match the same design to wok properly. The replacement of the slot (B2) may damage the vehicle.

### SUMMARY OF THE INVENTION

It is the primary object of the present invention to provide a connector structure for a vehicular light, which provides an insertion section that has a unified specification with a slot of a socket of a light base.

It is another object of the present invention to provide a connector structure for a vehicular light, which is convenient for installation with a light bulb of different specification.

It is a further object of the present invention to provide a connector structure for a vehicular light, which enables a single connector to connect with multiple lighting elements so as to save space and cost.

It is a further object of the present invention to provide a connector structure for a vehicular light, which enables to display different lighting colors and is more attractive.

### BRIEF DESCRIPTION OF THE DRAWINGS

FIG. 1 is a perspective view of the present invention;

FIG. 2 is a cross-sectional view of the present invention;

FIG. 3 is a cross-sectional view of the present invention incorporated with a vehicular light base; and

FIG. 4 is a cross-sectional view of the prior art.

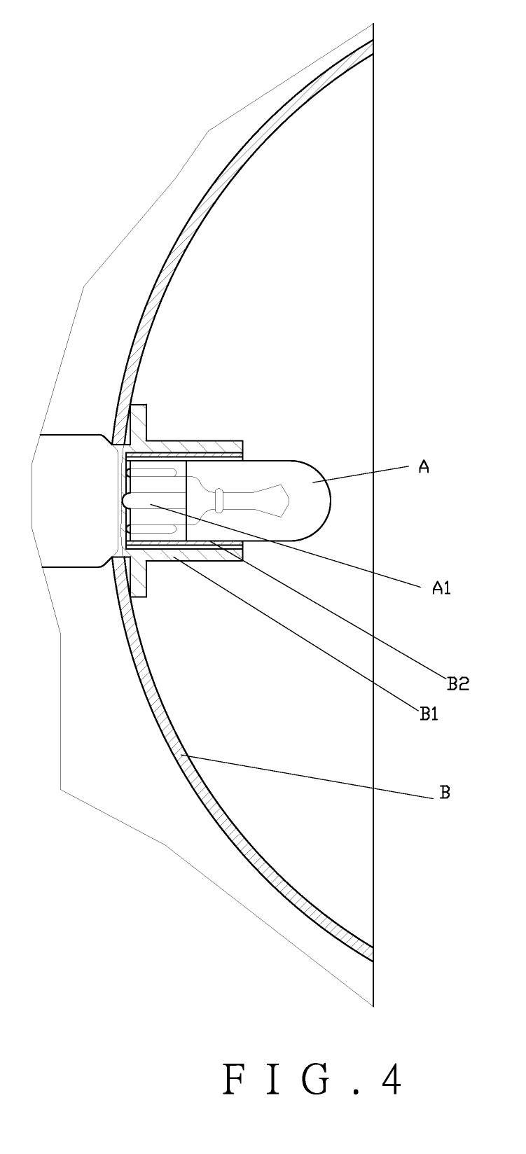

### DETAILED DESCRIPTION OF THE PREFERRED EMBODIMENT

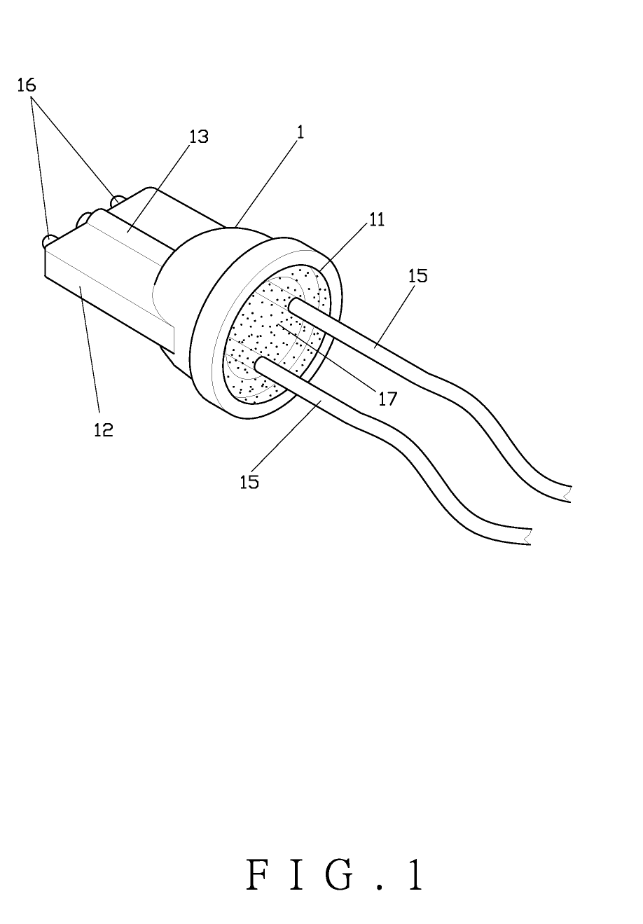

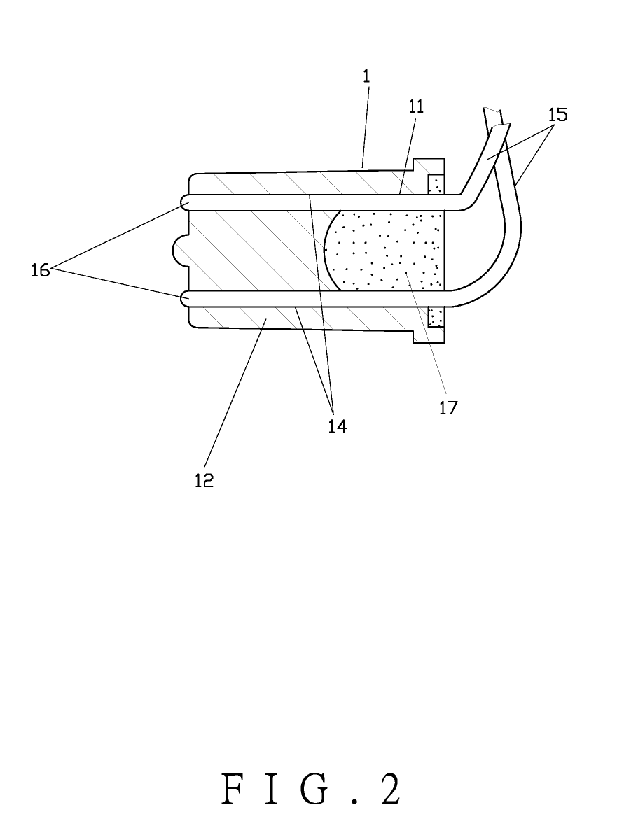

As shown in FIGS. 1 and 2, a preferred embodiment of the present invention comprises a connecting base (1). The connecting base (1) has a compartment (11) at one end and an insertion section (12) at the opposite end thereof. The insertion section (12) has a locating rib (13) thereon and a pair of holes (14) therein interconnecting with the compartment (11). The compartment (11) of the connecting base (1) is to accommodate a pair of electric wires (15) which extend through the holes (14) and connect with electric contact points (16) on the insertion section (12). The compartment (11) is sealed with gel (17) after the electric wires (15) are well installed and connected.

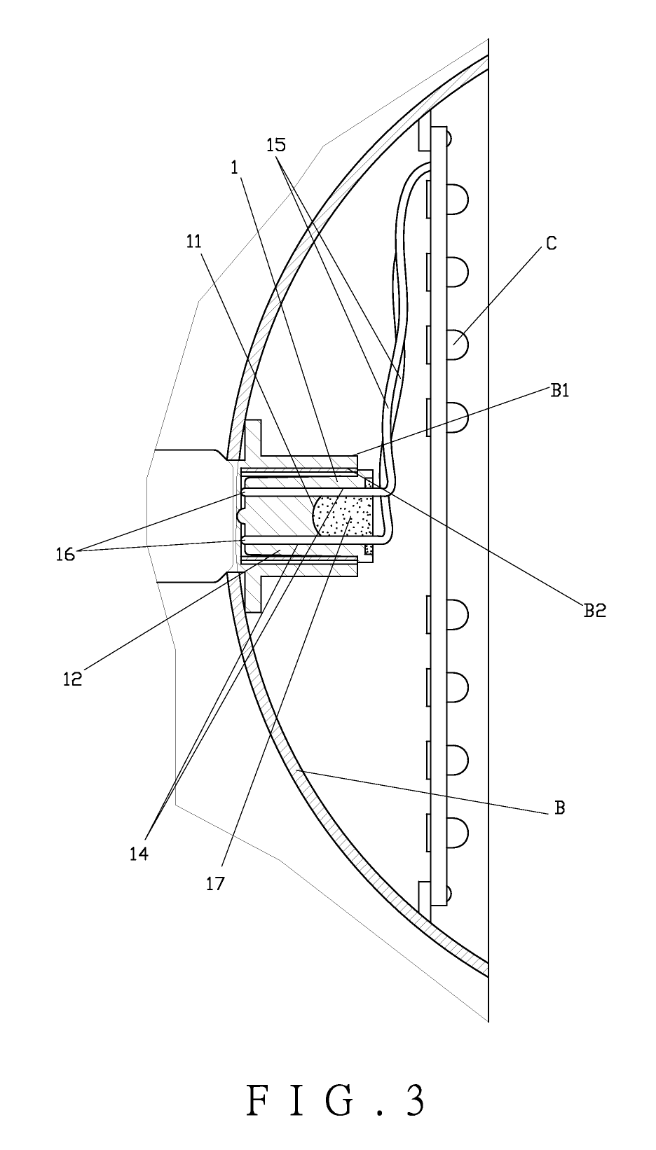

To operate the present invention, as shown in FIG. 3, each of the electric wires (15) has one end connected to a base provided with lighting elements (C), and the insertion section (12) of the connecting base (1) is inserted into a slot (B2) of a socket (B1) of a light base (B). The locating rib (13) of the insertion section (12) is positioned in the slot (B2), while the electric contact points (16) of the insertion section (12) are connected with the power supply from the slot (B2) of the socket (B1). When the vehicle is ignited and the vehicular light is turned on, the lighting elements (C) are illuminated. If multiple lighting element (C) are chosen, the electric wires (15) of the connecting base (1) are connected with the lighting elements (C) so that a single connecting base (1) may generate multiple lighting elements (C).

What is claimed is:

1. A connector structure for a vehicular light comprising a connecting base, said connecting base having a compartment at one end and an insertion section at another end thereof, said insertion section comprising holes therein interconnecting with said compartment and a locating rib thereon.

2. The connector structure for a vehicular light as recited in claim 1, wherein said compartment is provided with electric wires.

3. The connector structure for a vehicular light as recited in claim 2, wherein said electric wires extend through said holes and connect with electric contact points.

4. The connector structure for a vehicular light as recited in claim 1, wherein said compartment is sealed with gel.
